(19) United States
(12) Patent Application Publication
(10) Pub. No.: US 2012/0294119 A1
(43) Pub. Date: Nov. 22, 2012

(54) DEVICE FOR DETECTING ACOUSTIC WAVES AND A SYSTEM FOR LOCATING A SOURCE OF ACOUSTIC WAVES

(75) Inventor: Jean-Pierre Nikolovski, Chatenay-Malabry (FR)

(73) Assignee: Commissariat a l'energie atomiques et aux energies alternatives, Paris (FR)

(21) Appl. No.: 13/515,164

(22) PCT Filed: Dec. 14, 2010
(86) PCT No.: PCT/FR2010/052730

§ 371 Date: Jun. 11, 2012

(30) Foreign Application Priority Data
Jan. 8, 2010 (FR) 1050091

(51) Int. Cl. G01S 3/808; H04R 17/02

(52) U.S. Cl. 367/127; 367/180

(57) ABSTRACT

An acoustic wave detection device including a piezoelectric transducer configured to provide a detection signal; an acoustic resonator having a resonance frequency and including a resonating body having a free surface to be adhered against a substrate in which a seismic acoustic wave, having a frequency spectrum including the resonance frequency of the resonator, is propagated, the seismic acoustic wave causing the acoustic resonator to resonate by the free surface; and a microphone diaphragm having a frequency spectrum including the resonance frequency of the resonator. The diaphragm vibrates by an aerial acoustic wave that causes the acoustic resonator to resonate by the microphone diaphragm. The piezoelectric transducer is attached onto the acoustic resonator to produce a first component of detection signal, when the acoustic resonator resonates by the seismic acoustic wave, and produces a second component of detection signal when the acoustic resonator resonates by the aerial acoustic wave.

This invention concerns a device for detecting acoustic waves and a system for locating a source of acoustic waves.

An example of an application of the invention could be in detecting falls experienced by older or fragile persons living alone in their homes or other unusual situations affecting these people.

The French patent application published under number FR 2 879 885 outlines the principle of locating an impact on a plate by using the fact that this impact will generate a seismic acoustic wave in the plate. Locating is done by means of a method for calculating differential transit time between the point of impact and several pairs of devices for detecting the acoustic wave, each one of which contains a piezoelectric transducer. In this document, both devices of each pair are fixed to either side of a beveled edge of the plate This configuration—with the units fixed on either side of the plate and with the beveled edge—provides good sensitivity in the anti-symmetric propagation mode of the seismic wave through a lessening of the symmetric mode. The fact that one propagation mode is detected and not another is used to resolve the problem of the difference of propagation speed between the two modes.

However, the content of this document is only applicable where the plate is quite thin, has beveled edges and presents both of its sides in an accessible position.

Moreover, document FR 2 879 885 describes how the plate could eventually be used to act as an acoustic antenna and thus transmit voice compression waves to the acoustic detection wave units that then act as microphones. However, the plate cannot act as an acoustic antenna unless it is very thin.

It could thus be desirable that a device for detecting acoustic waves that is free of at least some of these aforementioned problems and constraints be made available.

To this end, an object of the invention is a device for detecting acoustic waves containing a piezoelectric transducer designed to send out a detection signal, and also an acoustic resonator featuring a resonance frequency and containing:
a resonant body with a free surface designed to be adhered against a substrate in which a seismic acoustic wave, having a frequency spectrum that incorporates the resonance frequency of the resonator, is intended to be propagated such that the seismic acoustic wave causes the acoustic resonator to resonate by means of said free surface, and
a microphone diaphragm designed to vibrate when an aerial acoustic wave having a frequency spectrum that incorporates the resonance frequency of the resonator acts upon it, so that the aerial acoustic wave causes the acoustic resonator to resonate by means of the microphone diaphragm,
   the piezoelectric transducer being fixed to the acoustic resonator such that it produces, on the one hand, a first component of detection signal when the acoustic resonator resonates as the seismic acoustic wave acts upon it, and on the other hand, a second component of detection signal when the acoustic resonator resonates as the aerial acoustic wave acts upon it.

In this way the acoustic resonator transmits both seismic and aerial acoustic waves to the piezoelectric transducer. In particular, aerial waves are detected without the assistance of any role the acoustic antenna of the substrate may play. The invention system may therefore be used as a dual-medium sensor (both aerial and solid media) regardless of the thickness or surface area of the substrate.

Moreover, the obtained detection device does not require having access to the two surfaces of the substrate and does not stipulate having beveled edges.

Optionally, the acoustic resonator may include a resonating disc comprising:
an annular peripheral part of a constant thickness with the piezoelectric transducer fixed at least partially to the annular peripheral piece, and
a circular central part containing the microphone diaphragm

Also optionally, the piezoelectric transducer comprises an annular piezoelectric element fixed to at least the peripheral part of the resonating disc.

Also optionally, the circular central part of the resonating disc features a thickness that diminishes progressing from its periphery to its center.

Also optionally, the device contains a cavity set into the acoustic resonator that is partially delineated by the microphone diaphragm.

Also optionally, the circular central part of the resonating disc features a constant thickness, less than the thickness of the peripheral annular part, so that the cavity has a cylindrical shape.

Also optionally:
the piezoelectric element is axially symmetrical according to a central axis, and features a fundamental resonance frequency in radial mode with relation to said central axis, and
the acoustic resonator is axially symmetrical according to said central axis, and features a fundamental resonance frequency in radial mode with relation to said central axis that is inferior to the fundamental resonance frequency of the piezoelectric element.

Also optionally, the fundamental resonance frequency of the acoustic resonator is between 1 and 10 kilohertz.

Also optionally, the acoustic resonator is made up of one single piece.

Another object of the invention is a system for locating a source of acoustic waves, including the following elements:
a substrate upon which a seismic acoustic wave is intended to propagate,
at least two acoustic wave detection devices according to the invention, the free surfaces of which are adhered against the substrate, and
a unit for processing the detection signals emitted by the acoustic wave detection units, with the processing unit designed to locate an emitting source of acoustic waves by means of calculating differential transit time from the detection signals emitted.

The features and benefits of the invention will appear in the description below of preferred embodiments of the invention, with said description provided solely for the purpose of giving an example. The description refers to the appended drawings in which:

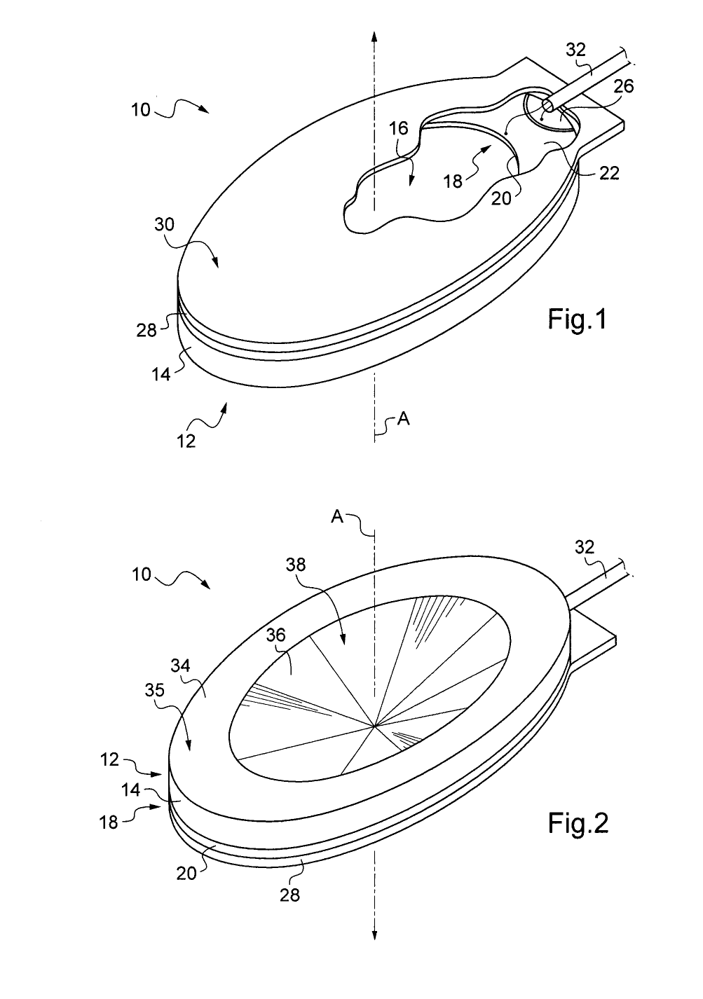

FIG. 1 is a three-dimensional top view of an acoustic wave detection device according to a first embodiment of the invention,

FIG. 2 is a three-dimensional view from underneath of the device shown in FIG. 1,

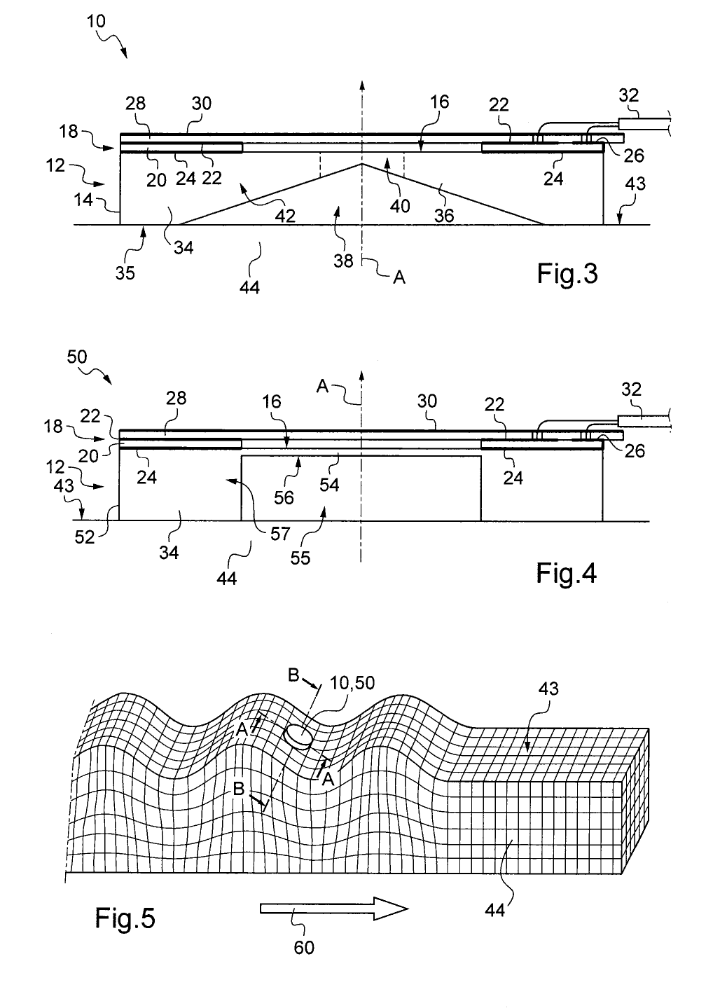

FIG. 3 is a cross sectional view of the device shown in FIG. 1,

FIG. 4 is a cross sectional view of an acoustic wave detection device according to a second embodiment of the invention,

FIG. 5 is a cross sectional view of a substrate in which a seismic acoustic wave propagates, and on which is fixed an acoustic wave detection device according to an embodiment of the invention,

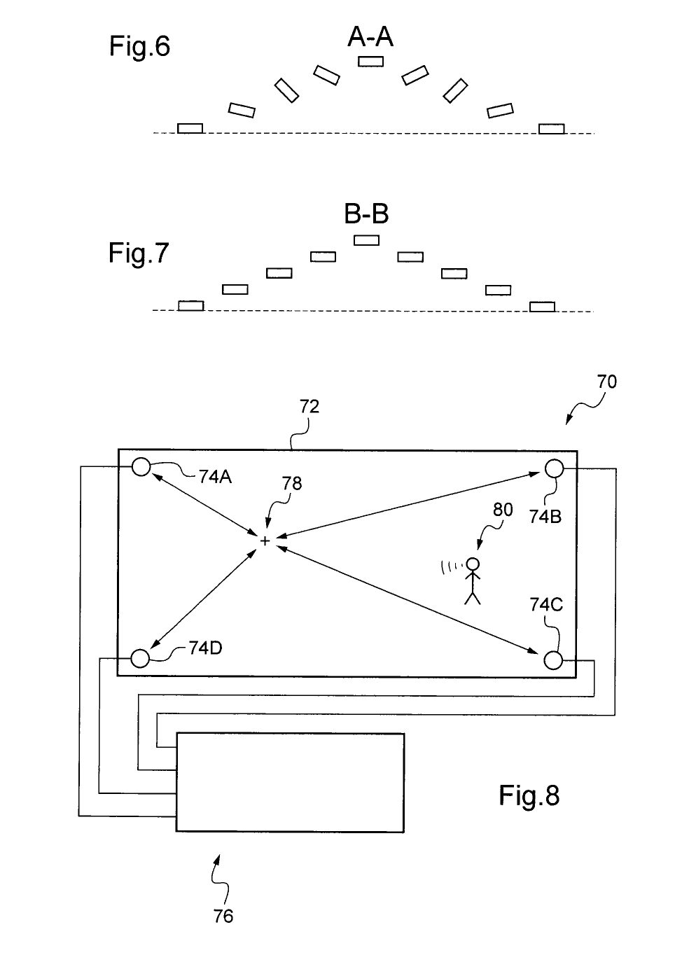

FIGS. 6 and 7 represent movement of the acoustic wave detection device shown in FIG. 5 when receiving a seismic acoustic wave, and

FIG. 8 is a schematic view of a system for locating a source of acoustic waves containing several acoustic wave detection devices per FIGS. 1 to 3 or FIG. 4.

An acoustic wave detection device 10 for seismic and aerial (also called microphonic) waves, according to a first embodiment of the invention, is shown in FIGS. 1 to 3.

In reference to FIG. 1, the device 10 contains first an acoustic resonator 12 intended to resonate when activated by a seismic or aerial acoustic wave, as will be explained below. The acoustic resonator 12 is made up of one single piece so as to effectively propagate acoustic waves, and is axially symmetric with relation to a central axis A. The central axis A is oriented from bottom to top in this description for additional clarity. However, it may be oriented in any way whatsoever. The acoustic resonator 12 is of metal preferably, for example aluminum or Duralumin (registered trademark). In the illustrated embodiment, the acoustic resonator 12 contains a resonating disc 14 centered on the central axis A with a flat upper surface 16.

The device 10 further contains a piezoelectric transducer 18 fixed to the upper surface 16 of the acoustic resonator 12. The piezoelectric transducer 18 contains an annular piezoelectric element 20, which is also axially symmetric with relation to central axis A. In the illustration shown in FIG. 1, the annular piezoelectric element 20 is in the form of a flat washer with an external diameter equal to that of the resonating disc 14. The piezoelectric element 20 could for example be in PZT ceramic. The piezoelectric transducer 18 further contains an upper electrode 22 made up of an electrically conducting layer, which could be silver paste, that can be soldered to cover an upper surface of the piezoelectric element 20, and a lower electrode 24 (visible in FIG. 3) also made up of an electrically conducting layer covering a lower surface of the piezoelectric element 20. The lower electrode 24 comprises a return 26 on the upper surface of the piezoelectric element 20 that facilitates its connection.

The piezoelectric transducer 18 has a very high fundamental resonance frequency in axially symmetric radial vibration mode, largely superior to the fundamental resonance frequency in axially symmetric radial vibration mode of the resonator 12.

The fundamental resonance of the resonator 12 is selected (by modifying its shape) depending on the substrate upon which it is to be fixed. For substrates of greater thickness, such as the floor of a residence, which propagate low frequency waves, the fundamental resonance frequency of the resonator 12 will preferably be between 1 kilohertz and 10 kilohertz. For locating applications on thin plates that propagate higher frequency waves, the resonator 12 will preferably be designed to furnish a fundamental resonance frequency of between 50 kilohertz and 100 kilohertz. For locating applications on thin plates which are further of smaller sizes, for example less than ten square meters, particularly around one square meter, it is advantageous to detect an impact by the aerial acoustic wave that it generates, primarily because this wave propagates at a single velocity, for example 343 meters per second at 20° C. This will act to resolve the problem of differences in velocities between the symmetric and anti-symmetric modes in a thin plate. In this case, the fundamental resonance frequency of the resonator is once again selected for between 1 kilohertz and 10 kilohertz.

As the resonator 12 has significantly greater volume than the piezoelectric transducer 18, it acts as a filter that lets through primarily those frequencies near its resonance frequencies, in particular near its fundamental resonance frequency. As such, the piezoelectric transducer is not subject to frequencies other than those near the resonance frequency of the resonator 12. The effect of this is to protect the piezoelectric transducer from higher frequencies and to obtain a detection signal near to this resonance frequency, which facilitates processing of this signal.

The detection device 10 further contains a printed circuit board, called PCB 28, circular in shape and fixed to the piezoelectric transducer 18, on its upper electrode 22 and on the return 26 of its lower electrode 24. The printed circuit board 28 is shown partially broken up in FIG. 1.

The device 10 further contains an upper conducting layer 30 covering an upper surface of the printed circuit board 28, the advantages of which will be detailed at a later time.

The device 10 further contains a coaxial cable 32, the core of which is connected to the upper electrode 22 and the shielding to the return 26 of the lower electrode of the piezoelectric transducer 18, via the printed circuit board 28.

In reference to FIG. 2, the resonating disc 14 includes a peripheral annular part 34 with a constant thickness and a flat lower annular surface 35. The lower annular surface 35 of the peripheral annular part 34 is a free surface, meaning that it is completely disengaged, designed to be adhered, as will be detailed below, against a substrate in which a seismic acoustic wave is intended to propagate, such that the seismic acoustic wave causes the acoustic resonator 12 to resonate by means of this free surface 35.

The resonating disc 14 further contains a circular central part 36 that fills in the interior circular space delineated by the peripheral annular part 34. The central part 36 features a diminishing thickness, progressing from the peripheral annular part 34 where this thickness is equal to that of the peripheral annular part, toward the central axis A where this thickness is minimal. The diminishing of thickness is for example linear. Thus a conical cavity 38 open toward the bottom is fitted in the acoustic resonator 12, this cavity 38 being delineated by the central part 36 of the resonating disc 14 and skirted by the lower annular surface 35.

In reference to FIG. 3, the acoustic resonator 12 contains a microphone diaphragm 40 with a thickness of under 1 millimeter, for example. In the example shown, the circular central part 36 of the resonating disc 14 contains the microphone diaphragm 40 that extends to the center of the circular central part 36, at the point where the thickness measures under 1 millimeter. The microphone diaphragm 40 is designed to vibrate when an aerial acoustic wave strikes against it, so that the aerial acoustic wave causes the acoustic resonator 12 to resonate by means of the microphone diaphragm 40.

The acoustic resonator 12 further contains a resonating body 42 of a thickness greater than that of the microphone diaphragm 40. In the example shown, the resonating body 42 is formed by the peripheral annular part and by the portion of the circular central part 36 extending around the diaphragm 40 at a thickness greater than 1 millimeter. In FIG. 3, the resonating body 42 and the microphone diaphragm 40 are separated by dotted lines.

As can be seen in FIG. 3, the cavity 38 is delineated partially by the microphone diaphragm 40.

Moreover, the piezoelectric transducer 18 is fixed to the body of the resonating disc 14, both onto the peripheral annular part 34 and on the circular central part 36. The piezoelectric transducer 18 is fixed by liquid glue, preferably cyanoacrylate glue, for example Loctite 407 (registered trademark), which enables the resonator 12 to apply a mechanical constraint to the piezoelectric transducer 18 when it resonates, with the result that the transducer emits a detection signal in the form of a potential difference between its lower electrode 24 and its upper electrode 22.

Preferably, the lower electrode 24 of the piezoelectric transducer 18 and the upper conducting layer 30 of the printed circuit 28 are both linked together, and connected to the electrical ground, for example, with both of them connected to the cable 32 sheath. The lower electrode 24 and the upper conducting layer 30 then form a Faraday cage covering the piezoelectric element 20 from above and below to protect it from external electrical interference, which improves measurements.

Preferably, the device 10 will have the following dimensions. The diameter of the resonating disc 14 should be between 20 millimeters and 100 millimeters, for example 50 millimeters. The peripheral annular part 34 should be between 1 and 5 millimeters thick, say 2 millimeters, while the center of the circular central part 36 should be between 0.1 and 1 millimeter thick, say for example 0.5 millimeter. The external diameter of the piezoelectric element 20 is equal to that of the resonating disc 14 and its internal diameter should be between 10 and 40 millimeters, say for example 20 millimeters. The piezoelectric element 20 is less than or equal to 1 millimeter thick, say for example 0.45 mm. Electrodes 22 and 24 and the conducting layer 30 should be less than or equal to 50 micrometers thick, say for example 35 micrometers.

Still with reference to FIG. 3, the device 10 is shown in a use position onto which it is fixed, by its free lower annular surface 35, to an upper surface 43 of a substrate 44 into which a seismic acoustic wave is intended to propagate. The free lower annular surface 35 of the device 10 may be glued to the upper surface 43 of the substrate 44, preferably with cyanoacrylate glue, say of the Loctite 407 type, or with an epoxy glue.

Since the free lower annular surface 35 surrounds the cavity 38, this cavity is closed by the substrate 44, such that the cavity 38 forms a resonant cavity for the diaphragm 40, meaning that pressure in the cavity is constant (with regard to the temporal length of an acoustic wave) in relation to pressure on the other side of the diaphragm 40. The cavity 38 will preferably be hermetically sealed to prevent any communication of air between the cavity 38 and the exterior of the cavity 38.

A acoustic wave detection device 50 according to a second embodiment of the invention is shown in FIG. 4. This device 50 is in great part similar to that shown in FIGS. 1 to 3, and the same references are used for identical elements. The only difference is the shape of the resonating disc, numbered at present as 52.

The resonating disc 52 contains a circular central part 54 of a constant thickness, less thick than the peripheral annular part 34. Thus a cavity 55 of a cylindrical shape is formed in the acoustic resonator 12, the cavity 55 being limited in height by the circular central part 54 and laterally by the peripheral annular part 34. Once the device 50 is fixed onto the substrate 44, the cavity 55 is delineated on the bottom by this substrate 44, as shown in FIG. 4.

In this embodiment, all of the circular central part 54 forms an acoustic diaphragm 56, while all of the peripheral annular part 34 forms a resonating body 57. In addition, the piezoelectric transducer 18 is fixed only onto the peripheral annular part 34 of the resonating disc 52.

It is preferable that the dimensions of the resonating disc 52 be as stated below (the other elements maintain the dimensions indicated in the first embodiment of the invention). The diameter of the resonating disc 52 should be between 20 millimeters and 100 millimeters, for example 50 millimeters. The peripheral annular part 34 should be between 1 and 5 millimeters thick, say 1 millimeter, while the center of the circular central part 54 should be between 0.1 and 1 millimeter thick, say for example 0.2 millimeter.

The acoustic resonator 12 then features a fundamental resonance frequency of 3.5 kilohertz in the axially symmetric radial vibration mode.

The device 50 according to the second embodiment is around three times more sensitive to aerial acoustic waves than the device 10 according to the first embodiment of the invention.

The functioning of devices 10 and 50, once fixed onto the substrate 44, will now be described.

With reference to FIG. 5, a seismic acoustic surface wave 60 propagates in the substrate 44, along its upper surface 43. The seismic acoustic wave 60 corresponds to a distortion that is propagating. The seismic acoustic wave 60 is, for example where the thickness of the substrate 44 is greater than its wave length, a Rayleigh wave (shown in FIG. 5) or else, where the substrate 44 is in plate form (of lesser thickness, at most around the dimensions of a wave length), a Lamb wave. In both cases, the seismic acoustic wave 60 comprises a component deemed “out of plane” that corresponds to a distortion of the material perpendicular to the upper surface 43 and a component deemed to be “in the plane”, which corresponds to a distortion of the material along the upper surface 43.

The acoustic resonator 12 is particularly sensitive to mechanical components of the seismic acoustic wave 60 for wave lengths equal to the double its diameter (amounting to 100 mm for an acoustic resonator 12 diameter of 50 mm), which corresponds to a functioning at its fundamental resonance frequency. In a plate, such vibrations may be transferred as readily in a symmetric mode as in an anti-symmetric mode, but in different proportions where the two modes are triggered by the same impact, which may bring up an issue of accuracy of location by differential transit time if the intensity of the impact is unknown. Any possible confusion in detection between symmetric and anti-symmetric modes is removed in state of the art units by using glued sensors facing each other on each side of the plate so as to totally differentiate the symmetric mode, which makes it possible to work with maximum gain amplified electronics. The state of the art leads practically and as a consequence to saturation of amplified electronics at the arrival of a seismic signal because it ignores any correlation that may exist between the seismic signal and the aerial signal resulting from the impact.

The risk of confusion between the symmetric and anti-symmetric modes is removed in a different manner by this invention. In the first place, by diminishing the working frequency (for a like plate thickness) in order to diminish the proportion of symmetric mode contained in the signal relative to the anti-symmetric mode. In the second place, a weaker gain is used so as to provide a range of amplitude variation and to be able to measure the intensity of the impact directly at the head of the wave group by analog/digital conversion (in the state of the art, intensity is quantified by measuring the reverberation time of the seismic signal on the plate). In the third place, the signal is analyzed over a longer period of time by using the microphone signal emerging from the impact.

The Fourier analyses and analyses of the temporal shape of signals within the second that follows an impact is used to determine the type and intensity of the impact and the interaction mode, as well as, a posteriori, what should be the amplitude of the seismic signal within the 10 milliseconds following impact. These analyses are particularly useful in checking whether maximum amplitude expected for the symmetric mode is of a type that will distort locating operations where seismic signals are being used. This is all the more true when the interaction type is known, for example for an impact with pulp, the flat part of the wave or fingertips (flesh and fingernail).

A second method for removing the risk of confusion consists in using the microphone signal resulting from the impact and determining location by differential transit time on the aerial wave.

The acoustic resonator 12 will resonate in accordance with the axially symmetric radial vibration mode when the frequency spectrum of the seismic acoustic wave 60 comprises at least one resonance frequency in accordance with this mode, preferably the fundamental resonance frequency in accordance with this mode, since it is generally that which produces the strongest resonance. Thus the seismic acoustic wave 60 causes the acoustic resonator 12 to resonate by means of the lower annular surface 35.

The acoustic resonator 12 thus caused to resonate then applies a mechanical constraint on the piezoelectric transducer 18, which generates a difference in potential between electrodes 22 and 24, with this difference in potential making up a component of the detection signal, subsequently referred to as the seismic component.

In addition, an aerial acoustic wave that is propagating in the surrounding air touches the microphone diaphragm 40 or 56. The action of the aerial acoustic wave causes the microphone diaphragm 40 or 56 to vibrate, such that the aerial acoustic wave causes the acoustic resonator 14 to resonate by means of the microphone diaphragm 40, also in accordance with the axially symmetric radial resonance mode.

The acoustic resonator 12 thus caused to resonate then applies a mechanical constraint on the piezoelectric transducer 18, which generates a difference in potential between electrodes 22 and 24, with this difference in potential making up a component of the detection signal, subsequently referred to as the microphone component.

The detection signal provided by the device 10 or 50 thus comprises the seismic component or the microphone component, depending on whether it is a seismic acoustic or an aerial acoustic wave that has been received. Note that the acoustic resonator 12 acts as a frequency filter on the seismic or aerial acoustic wave. Indeed, the wave frequencies corresponding to the resonance frequencies, and in particular to the fundamental resonance frequency, are very strong when sent out, whereas the frequencies outside of the resonance frequency are significantly diminished.

In reference to FIG. 8, a system 70 for locating a source of acoustic waves contains a substrate 72 in the form of a plate. The substrate 72 could be for example the floor of a residence, or a much thinner flat surface, such as a table.

The system 70 also contains four acoustic wave detection devices, 74A, 74B, 74C and 74D that are attached to the substrate. Each of these devices 74A, 74B, 74C and 74D conforms either to the first embodiment of the invention, as shown in FIGS. 1 to 3, or to the second embodiment in FIG. 4. Each of these devices 74A, 74B, 74C and 74D sends out a detection signal comprising a seismic component when a seismic acoustic wave is detected by the device, by means of its surface 35 adhered to the substrate, or a microphone component, when an acoustic microphone wave is detected by the device through its microphone diaphragm 40 or 56.

The system 70 further contains a unit 76 for processing detection signals of devices 74A, 74B, 74C and 74D.

The processing unit 76 is designed to detect activity around a predetermined frequency in each of the detection signals. It is preferable that the predetermined frequency be equal to the fundamental resonance frequency of devices 74A, 74B, 74C and 74D in their axially symmetrical radial vibration mode.

Activity corresponds either to the presence of a seismic component in the detection signal or to the presence of a microphone component, or to the presence of both seismic and microphone components.

Detection is carried out by means of a broad band amplification, followed by filtering around the predetermined frequency, then by a squarer, then peak detection and then integration.

When the processing unit 76 detects a first activity, meaning activity that was not recently preceded by another activity, the processing unit initializes meters that are used to timestamp all activities detected subsequently over a pre-determined interval of time, with relation to this first activity.

An acoustic impulse source, such as an impact, generally generates a seismic wave and an aerial wave. For example, an impact on the substrate 72 will generate a seismic wave, as well as a noise, meaning an aerial wave. In the same manner, clapping one's hands generates a sound, in other words an aerial wave that propagates to a substrate 72 and generates a seismic wave in the substrate. Since seismic waves propagate much more rapidly than do aerial waves, the first activity generally corresponds to the detection of a seismic wave.

The processing unit 76 is designed to distinguish between activities wich correspond to diverse interaction forms, for example impacts, that are characterized by an impulsion wave type comprising at the beginning a signal of weak amplitude that corresponds to the arrival of the seismic wave, followed by a stronger amplitude signal that corresponds to the arrival of the microphone wave. An interaction form of the type where hands are clapped does not produce a signal corresponding to the arrival of a seismic wave, but rather solely to a microphone signal. In a noisy sound environment, the processing electronics can be programmed to not react the this type of interaction.

The processing unit 76 is therefore designed to distinguish between the activities corresponding to a seismic wave from those corresponding to an aerial wave, for example through the fact that they feature the same signature, since they have the same interaction form (the impact on the substrate having an initial form of interaction and the clapping of hands a second form).

The processing unit 76 is designed to locate the source using time stamped detections. This is accomplished for example in the manner described in publication FR 2811 107, that is, by calculating differential transit time either from seismic wave detections or from aerial wave detections.

Where seismic wave detections are used, it is possible to locate a source on the substrate 72. It is also possible to pinpoint an aerial source resulting from an impact or an aerial source with no impact.

Where aerial wave detections are used, it is possible to locate a source on a substrate or even from a distance from the substrate (for example a clapping of hands).

Using aerial wave detections can offer certain benefits. When the substrate is a thin plate, for example a glass plate 1 centimeter thick, an impact generates a seismic wave comprising a symmetric mode that propagates, say, at the velocity of 5,400 meters per second, and a slower anti-symmetric mode that propagates say at 3,300 meters per second, as well as an aerial wave that propagates at, say 343 meters per second. Using the aerial wave avoids the issue of different velocities of the two modes of the seismic wave.

Moreover, with the use of the aerial wave, the substrate is used to determine the work surface and the attachment locations of the detection devices. It also serves as a barrier and a guide for aerial waves generated by the impact that should propagate laterally toward the sensors.

Using acoustic microphone waves to detect an impact is also beneficial because by judiciously choosing the seismic surface/microphone surface ratio for the sensor, it is possible to ensure that the acoustic waves produce a signal that is much stronger, generally ten times stronger, than seismic waves.

Furthermore, in the seismic waves that are generated, the anti-symmetric mode is much stronger, generally ten times stronger, than the symmetric mode, and this is even more true as the frequency diminishes, or more precisely, as the thickness-frequency product remains weak, preferentially below 100 kHz.mm. Thus by choosing a weak resonance frequency for the resonator, the proportion of the anti-symmetric mode triggered by the impact remains relatively low in proportion to the anti-symmetric mode, such that the symmetric mode may be considered for all practical purposes as absent. Working with low frequencies therefore results in improving selectiveness and sensitivity, but it works against temporal resolution and consequently accuracy in locating, except when using aerial waves originating from the impact, for which the absence of dispersion can be used to identify a fixed point in an incoming wave group with greater accuracy than the half period of the signal.

Moreover, the processing unit 76 shall be designed to record detection signals, preferably over a sliding period of recording, for example for a duration of 3 to 5 seconds. It is preferable that, when an impact is detected, meaning that a seismic acoustic source is located by the processing unit 76, the unit should extend the recording interval by several seconds, say between 3 to 5 seconds. The processing unit 76 is then designed to analyze, for example by means of a Fourier analysis, detection signals recorded over the recording interval extended as described.

Thus the processing unit 76 is able to detect sound activity preceding and following the impact, since this sound activity then triggers a microphone component in at least one of the detection signals. The analysis comprises the determination of the type of sound activity, for example by comparing recorded signals with a database of reference signals.

In monitoring older or infirm persons, the system 70 can be used to detect an emergency situation from both seismic and microphonic information, for example, an impact followed by a cry that could be the result of a person falling down.

It appears clearly that an acoustic wave detection device according to the invention can detect seismic and aerial acoustic waves on a substrate with only one accessible side that does not necessarily present beveled edges.

It should be noted moreover, that the invention is not limited to the embodiments described previously. It will be clear to a person skilled in the art that various modifications may be made to the embodiments described above in view of the information that has just been presented. Terms used in the claims that follow should not be interpreted as limiting the claims to the embodiments described in this document, but should be interpreted so as to incorporate all equivalent terms that the claims seek to cover as a result of them being formulated and for which providing for them is within the reach of a person skilled in the art by applying general knowledge to putting the information that is presented herein into effect.

1-10. (canceled)

11. A device for detecting acoustic waves comprising:
a piezoelectric transducer configured to send out a detection signal;
an acoustic resonator featuring a resonance frequency and including:
a resonant body including a free surface configured to be adhered against a substrate in which a seismic acoustic wave, having a frequency spectrum that incorporates the resonance frequency of the resonator, is to be propagated such that the seismic acoustic wave causes the acoustic resonator to resonate by the free surface, and
a microphone diaphragm configured to vibrate when an aerial acoustic wave having a frequency spectrum that incorporates the resonance frequency of the resonator acts upon it, so that the aerial acoustic wave causes the acoustic resonator to resonate by the microphone diaphragm;
the piezoelectric transducer being fixed to the acoustic resonator such that it produces (1) a first component of detection signal when the acoustic resonator resonates as the seismic acoustic wave acts upon it and (2) a second component of detection signal when the acoustic resonator resonates as the aerial acoustic wave acts upon it.

12. An acoustic wave detection device according to claim 11, wherein the acoustic resonator includes a resonating disc that includes:
an annular peripheral part of a constant thickness with the piezoelectric transducer fixed at least partially to the annular peripheral part, and
a circular central part including the microphone diaphragm.

13. An acoustic wave detection device according to claim 12, wherein the piezoelectric transducer includes an annular piezoelectric element fixed to at least the peripheral part of the resonating disc.

14. An acoustic wave detection device according to claim 12, wherein the circular central part of the resonating disc has a thickness that diminishes progressing from its periphery to its center.

15. A detection device according to claim 11, further comprising a cavity set into the acoustic resonator that is partially delineated by the microphone diaphragm.

16. An acoustic wave detection device according to claim 12, wherein the circular central part of the resonating disc has a constant thickness, less than the thickness of the peripheral annular part, such that the cavity has a cylindrical shape.

17. An acoustic wave detection device according to claim 11, wherein:
the piezoelectric element is axially symmetrical according to a central axis, and has a fundamental resonance frequency in radial mode with relation to the central axis, and
the acoustic resonator is axially symmetrical according to the central axis, and has a fundamental resonance frequency in radial mode with relation to the central axis that is inferior to the fundamental resonance frequency of the piezoelectric element.

18. An acoustic wave detection device according to claim 17, wherein the fundamental resonance frequency of the acoustic resonator is between 1 and 10 kilohertz.

19. An acoustic wave detection device according to claim 11, wherein the acoustic resonator is made of one single piece.

20. A system for locating a source of acoustic waves, comprising:
a substrate upon which a seismic acoustic wave is to propagate;
at least two acoustic wave detection devices according to claim 11, free surfaces of which are adhered against the substrate; and
a unit for processing the detection signals emitted by the acoustic wave detection units, with the processing unit configured to locate an emitting source of acoustic waves by calculating a differential transit time from the detection signals emitted.
